(19) United States
(12) Patent Application Publication
(10) Pub. No.: US 2013/0318794 A1
(43) Pub. Date: Dec. 5, 2013

(54) Method of Coupling Diatonic Harmonicas

(71) Applicant: William Montgomery PRICE, North Adams, MI (US)

(72) Inventor: William Montgomery PRICE, North Adams, MI (US)

(21) Appl. No.: 13/909,806

(22) Filed: Jun. 4, 2013

Related U.S. Application Data
(60) Provisional application No. 61/655,005, filed on Jun. 4, 2012.

(51) Int. Cl. G10D 7/12

(52) U.S. Cl. CPC G10D 7/123
USPC 29/896.22

(57) ABSTRACT

A method of coupling diatonic harmonicas that increases the musical range of the diatonic harmonicas being coupled. Diatonic harmonicas are stacked and secured together by a clamping mechanism in order to form an instrumental assembly that is more versatile than a single diatonic harmonica. An ideal key is first determined according to a selected musical piece. The ideal key provides a foundation from which an initial harmonica and a subsequent harmonica are selected from a plurality of harmonicas. Each of the plurality of harmonicas is tuned in a musical key that is either major or minor. The musical key of the initial harmonica is determined according to the ideal key, while the musical key of the subsequent harmonica is determined from the chromatic scale. Once the initial harmonica and the subsequent harmonica are selected, they are coupled together by the clamping mechanism.

The current application claims a priority to the U.S. Provisional Patent application Ser. No. 61/655,005 filed on Jun. 4, 2012.

### FIELD OF THE INVENTION

The present invention relates generally to a method of combining musical instruments. More specifically, the present invention provides a method for coupling or stacking diatonic harmonicas in order to expand their range and overall capability. The method described hereinafter reveals how the diatonic harmonica is enabled to perform beyond the limits of its design.

### BACKGROUND OF THE INVENTION

The harmonica is a free reed wind instrument that has been used for decades in blues, rock, folk, jazz and many other genres of music. One of the most common types of harmonicas is the diatonic harmonica. Diatonic harmonicas allow musicians to play the notes on a diatonic scale and can be tuned in either a major or minor key. A standard ten hole diatonic harmonica can play the notes from a diatonic scale in three octaves. However, only the middle octave has a complete diatonic scale. Additionally, a single diatonic harmonica is limited in the number of chords that it can produce. Due to the nature of the diatonic harmonica, it is often used only to perform the harmony in musical pieces, as it does not have the full range to support numerous melodies on its own. While a single diatonic harmonica may not provide all of the notes needed to play a song, the missing notes can be found on diatonic harmonicas tuned in different keys.

Therefore it is the object of the present invention to provide a method of coupling diatonic harmonicas. Diatonic harmonicas being tuned in different keys are stacked together in order to provide complete diatonic scales in all of the diatonic harmonica's octaves. Using the methods provided by the present invention, reference charts are formed for coupling major diatonic harmonicas to major diatonic harmonicas, minor diatonic harmonicas to minor diatonic harmonicas, and major diatonic harmonicas to minor diatonic harmonicas. Diatonic harmonicas are selected from a plurality of harmonicas according to a desired musical piece, and are secured together with a clamping mechanism in order to form an instrumental assembly. The created instrumental assembly allows a user to play the melody of a song, as the process of coupling diatonic harmonicas provides additional diatonic and/or chromatic notes, as well as additional chords. The result of additional notes and chords being available to the user is an instrument that is more versatile than a standalone diatonic harmonica.

### BRIEF DESCRIPTION OF THE DRAWINGS

FIG. 1 is a perspective view of two diatonic harmonicas coupled together.

FIG. 2 is a diagram depicting the available notes on diatonic harmonic tuned in the musical key of C major.

FIG. 3 is a perspective view of a diatonic harmonica in the musical key of B-flat and a diatonic harmonica in the musical key of C coupled together in order to complete diatonic scales in three octaves.

FIG. 4 is a flowchart outlining the process for selecting and coupling diatonic harmonicas.

FIG. 5 is a reference chart for coupling an initial harmonica tuned in a major musical key to a subsequent harmonica tuned in a major musical key.

FIG. 6 is a reference chart for coupling an initial harmonica tuned in a minor musical key to a subsequent harmonica tuned in a minor musical key.

FIG. 7 is a reference chart for coupling an initial harmonica tuned in a minor musical key to a subsequent harmonica tuned in a major musical key.

FIG. 8 is a flowchart outlining the process for determining the major musical key of a subsequent harmonica to be coupled to an initial harmonica tuned in a major musical key.

FIG. 9 is a flowchart outlining the process for determining the minor musical key of a subsequent harmonica to be coupled to an initial harmonica tuned in a minor musical key.

FIG. 10 is a flowchart outlining the process for determining the minor musical key of a subsequent harmonica to be coupled to an initial harmonica tuned in a major musical key.

FIG. 11 is a flowchart outlining the process for determining the major musical key of a subsequent harmonica to be coupled to an initial harmonica tuned in a minor musical key.

FIG. 12 is a perspective view of an instrumental assembly formed by coupling a diatonic harmonica tuned in the musical key of A-flat, a diatonic harmonica tuned in the musical key of B-flat, and a diatonic harmonica tuned in the key of G minor.

### DETAILED DESCRIPTION OF THE INVENTION

All illustrations of the drawings are for the purpose of describing selected versions of the present invention and are not intended to limit the scope of the present invention.

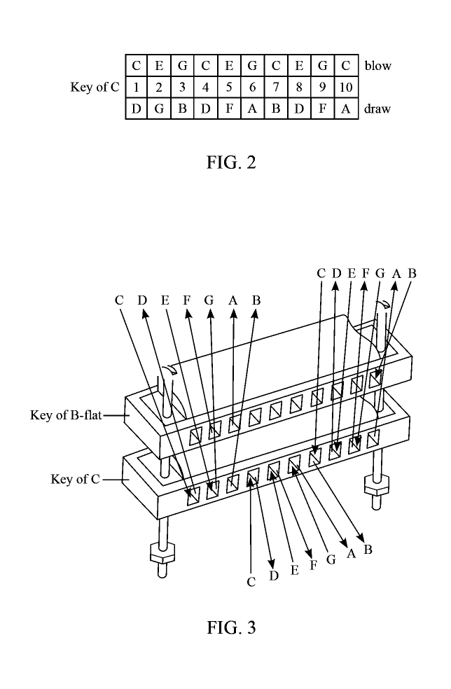

The present invention is a method of coupling diatonic harmonicas in order to increase the musical range of the diatonic harmonicas being coupled together. A standard ten hole diatonic harmonica can play notes in three octaves. However, only the middle octave has a complete diatonic scale. As shown in FIG. 2, a diatonic harmonica tuned in the key of C major is missing the A and F notes in the first octave and the B note in the third octave. By coupling diatonic harmonicas tuned in different keys, complete diatonic scales can be formed in all three octaves. FIG. 3, shows a diatonic harmonica tuned in the key of B-flat major being coupled to a diatonic harmonica tuned in the key of C major. It can be seen that by coupling these two diatonic harmonicas, a full diatonic scale can be performed in three octaves.

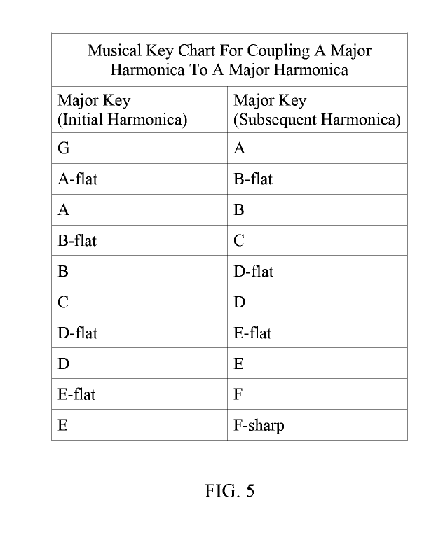

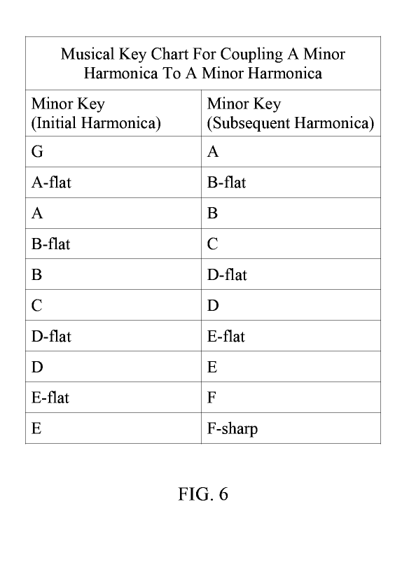

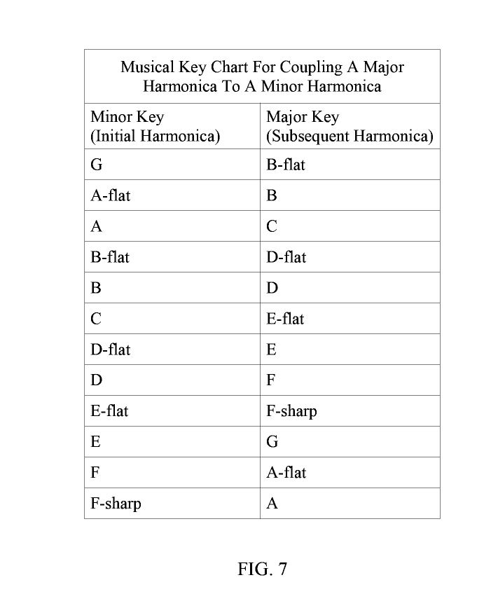

Diatonic harmonicas cannot be randomly attached to one another in order to create complete diatonic scales throughout three octaves, rather diatonic harmonicas must be stacked according to unique methods. Methods are provided for coupling a major diatonic harmonica to a major diatonic harmonica, a minor diatonic harmonic to a minor diatonic harmonica, and a major diatonic harmonica to a minor diatonic harmonica. These formulas can be used to create charts, as shown in FIG. 5-7, which can be used as quick references for coupling diatonic harmonicas. Provided a plurality of harmonicas, the present invention allows a user to select the appropriate diatonic harmonicas to couple together in order to perform a musical piece. Each of the plurality of harmonicas is tuned in a musical key that can be either major or minor. The musical key determines the notes that can be played by each of the plurality of harmonicas, as well as the positioning of notes along each of the plurality of harmonicas.

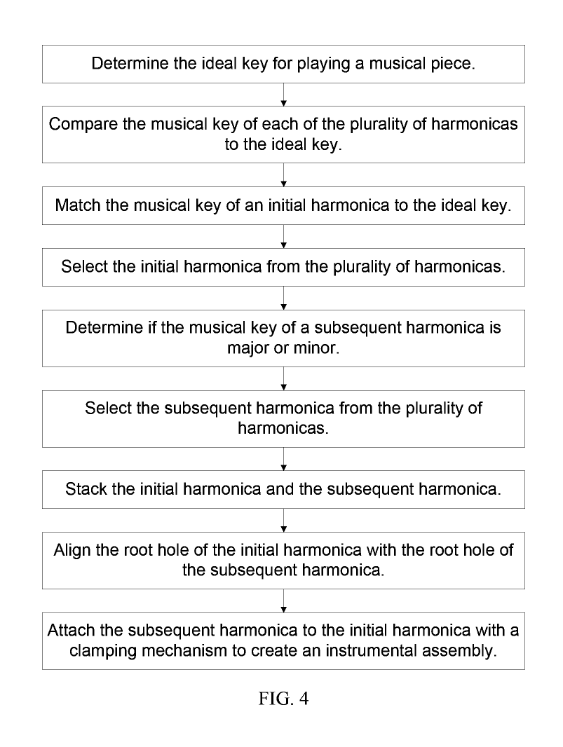

In reference to FIG. 4, to determine the correct diatonic harmonicas to couple, a user must first choose the musical piece that they would like to play. Once the desired musical piece has been selected, the user must then determine an ideal key in order to encompass musical notes within the musical piece. The ideal key is most commonly selected as the musical key corresponding to the diatonic harmonica which provides the widest range of notes or the best position of notes that are needed to play the musical piece. However, the ideal key may be any musical key in which the user chooses to play the musical piece.

The musical key of each of the plurality of harmonicas is compared to the ideal key. Musical keys are continuously compared until the musical key of an initial harmonica is matched to the ideal key. The initial harmonica is then selected from the plurality of harmonicas. Once the initial harmonica has been determined, the user can select a subsequent harmonica from the plurality of harmonicas in order to expand the musical range of the initial harmonica. First the user must determine if the musical key of the subsequent harmonica is to be major or minor in order to encompass musical notes within the musical piece that are not provided by the initial harmonica. Once the user has determined if the musical key of the subsequent harmonica is to be major or minor, the charts shown in FIG. 5-7 can then be used to select the subsequent harmonica that is appropriately tuned. These charts are created by moving along the chromatic scale, starting with the musical key of the initial harmonica. A ‘step’ is hereinafter defined as moving one position in either direction on the chromatic scale and, as such, may be either a half musical step or a whole musical step, as will become apparent in the following examples.

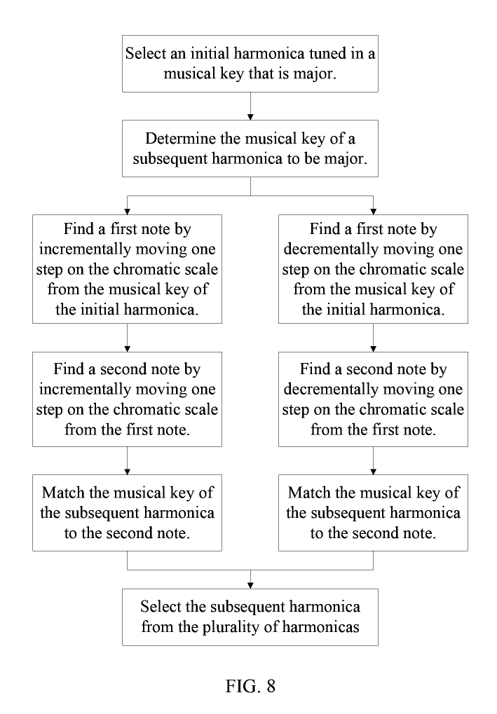

The charts shown in FIG. 5-7, are created using the following methods. In reference to FIG. 8, if the musical key of both the initial harmonica and the subsequent harmonica is major, then a first note and a second note are found on the chromatic scale. The musical key of the subsequent harmonica is then matched to the second note in order to determine the subsequent harmonica to select from the plurality of harmonicas. The first note and the second note can be found in one of two ways. In one embodiment, where the musical key of both the initial harmonica and subsequent harmonica is major, the first note is found by incrementally moving one step on the chromatic scale from the musical key of the initial harmonica. The second note is then found by incrementally moving one step on the chromatic scale from the first note. For example, if the musical key of the initial harmonica is C, then the first note would be D-flat, while the second note would be D. The diatonic harmonica tuned in D major would then be selected from the plurality of harmonicas as the subsequent harmonica.

In another embodiment, where the musical key of both the initial harmonica and subsequent harmonica is major, the first note is found by decrementally moving one step on the chromatic scale from the musical key of the initial harmonica. The second note is then found by decrementally moving one step on the chromatic scale from the first note. For example, if the musical key of the initial harmonica is C, then the first note would be B, while the second note would be B-flat. The diatonic harmonica tuned in B-flat major would then be selected from the plurality of harmonicas as the subsequent harmonica.

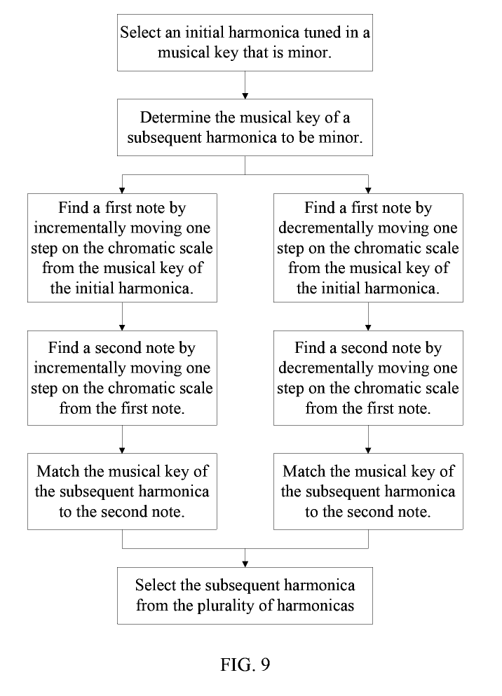

In reference to FIG. 9, coupling two diatonic harmonicas tuned in a musical key that is minor is similar to coupling two diatonic harmonicas tuned in a musical key that is major. If the musical key of both the initial harmonica and the subsequent harmonica is minor, then a first note and a second note must be found on the chromatic scale. The musical key of the subsequent harmonica is then matched to the second note in order to determine the subsequent harmonica to select from the plurality of harmonicas. The first note and the second note can be found in one of two ways. In one embodiment, where the musical key of both the initial harmonica and subsequent harmonica is minor, the first note is found by incrementally moving one step on the chromatic scale from the musical key of the initial harmonica. The second note is then found by incrementally moving one step on the chromatic scale from the first note. For example, if the musical key of the initial harmonica is C, then the first note would be D-flat, while the second note would be D. The diatonic harmonica tuned in D minor would then be selected from the plurality of harmonicas as the subsequent harmonica.

In another embodiment, where the musical key of both the initial harmonica and subsequent harmonica is minor, the first note is found by decrementally moving one step on the chromatic scale from the musical key of the initial harmonica. The second note is then found by decrementally moving one step on the chromatic scale from the first note. For example, if the musical key of the initial harmonica is C, then the first note would be B, while the second note would be B-flat. The diatonic harmonica tuned in B-flat minor would then be selected from the plurality of harmonicas as the subsequent harmonica.

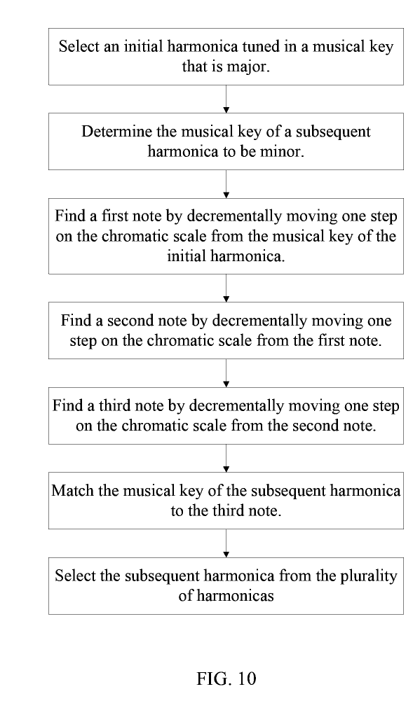

In reference to FIG. 10, if the musical key of the initial harmonica is major and the musical key of the subsequent harmonica is minor, then a first note, a second note, and a third note must be found on the chromatic scale. The musical key of the subsequent harmonica is then matched to the third note in order to determine the subsequent harmonica to select from the plurality of harmonicas. The first note is found by decrementally moving one step on the chromatic scale from the musical key of the initial harmonica. The second note is then found by decrementally moving one step on the chromatic scale from the first note, and the third note is found by decrementally moving one step on the chromatic scale from the second note. For example, if the musical key of the initial harmonica is C major, then the first note would be B, while the second note would be B-flat and the third note would be A. The diatonic harmonica tuned in A minor would then be selected from the plurality of harmonicas as the subsequent harmonica.

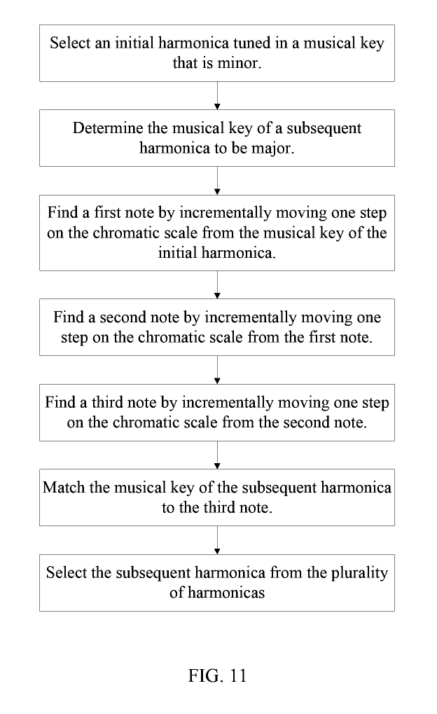

In reference to FIG. 11, if the musical key of the initial harmonica is minor and the musical key of the subsequent harmonica is major, then a first note, a second note, and a third note must be found on the chromatic scale. The musical key of the subsequent harmonica is then matched to the third note in order to determine the subsequent harmonica to select from the plurality of harmonicas. The first note is found by incrementally moving one step on the chromatic scale from the musical key of the initial harmonica. The second note is then found by incrementally moving one step on the chromatic scale from the first note, and the third note is found by incrementally moving one step on the chromatic scale from the second note. For example, if the musical key of the initial harmonica is A minor, then the first note would be B-flat, while the second note would be B and the third note would be C. The diatonic harmonica tuned in C major would then be selected from the plurality of harmonicas as the subsequent harmonica. It is possible for the subsequent harmonica to be selected using different methods than those described above, however, the methods described above are intended to provide the user with diatonic harmonicas that best supplement one another.

In further reference to FIG. 4, when both the initial harmonica and the subsequent harmonica have been selected from the plurality of harmonicas, the initial harmonica and the subsequent harmonica are stacked together. In the preferred embodiment of the present invention, the diatonic harmonic tuned in the lower musical key is stacked on top of the diatonic harmonic tuned in the higher musical key. However, the diatonic harmonic tuned in the higher musical key can also be stacked on top of the diatonic harmonic tuned in the lower musical key. Each of the plurality of harmonicas comprises a root hole, which is used to properly align the subsequent harmonica with the initial harmonica. The root hole of each of the plurality of harmonicas also corresponds to the first note of the respective scale of each of the plurality of harmonicas. Aligning the root hole of the initial harmonica to the root hole of the subsequent harmonica ensures that the notes are properly positioned along both the initial harmonica and the subsequent harmonica in order to complete the diatonic scale in three octaves.

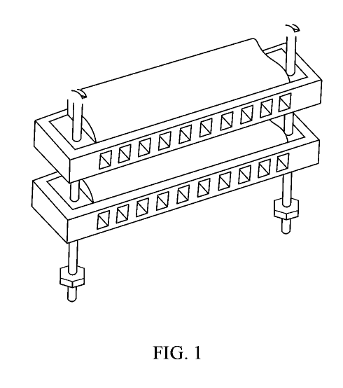

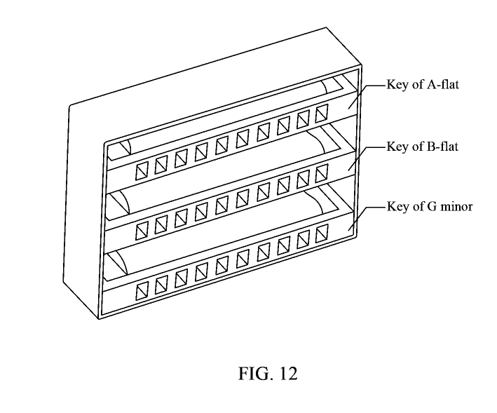

After the initial harmonica and the subsequent harmonica are stacked together and properly aligned with each other, they are secured together using a clamping mechanism in order to create an instrumental assembly for the ideal key. The instrumental assembly is played as a single instrument and provides all of the notes needed to play the desired musical piece. In reference to FIG. 1, in one embodiment of the present invention, the clamping mechanism comprises a pair of nuts and bolts, and traverses through both the initial harmonica and the subsequent harmonica. Each of the pair of bolts is threaded through one end of the initial harmonica and the subsequent harmonica. The pair of nuts is then threaded onto the pair of bolts in order to hold the pair of bolts in place and secure the subsequent harmonica to the initial harmonica. In reference to FIG. 12, in another embodiment of the present invention, the clamping mechanism perimetrically encompasses the initial harmonica and the subsequent harmonica. The clamping mechanism comprises a frame structure capable of supporting a predetermined number of diatonic harmonicas. The initial harmonica and the subsequent harmonica are held in place within the frame structure by a frictional fit. In addition to the embodiments described above, the clamping mechanism can be any other device that securely holds the initial harmonica and subsequent harmonica together without causing interference while the instrumental assembly is played.

The method of coupling diatonic harmonicas can be repeated as many times as necessary in order to create the instrumental assembly having the necessary number of diatonic harmonicas to play the selected musical piece. In many cases when more than two diatonic harmonicas are coupled, the subsequent harmonica will act as the initial harmonica, providing a new starting point for adding diatonic harmonicas.

Although the invention has been explained in relation to its preferred embodiment, it is to be understood that many other possible modifications and variations can be made without departing from the spirit and scope of the invention as hereinafter claimed.

What is claimed is:

1. A method of coupling diatonic harmonicas comprises the steps of:
providing a plurality of harmonicas, wherein each of the plurality of harmonicas comprises a root hole and is tuned in a musical key;
determining an ideal key in order to encompass musical notes within a musical piece;
comparing the musical key of each of the plurality of harmonicas to the ideal key;
matching the musical key of an initial harmonica to the ideal key;
selecting the initial harmonica from the plurality of harmonicas;
determining if the musical key of a subsequent harmonica is major or minor in order to encompass musical notes within the musical piece;
selecting the subsequent harmonica from the plurality of harmonicas by starting with the musical key of the initial harmonica and moving along the chromatic scale;
stacking the initial harmonica and the subsequent harmonica;
aligning the root hole of the initial harmonica with the root hole of the subsequent harmonica; and
attaching the subsequent harmonica to the initial harmonica with a clamping mechanism in order to create an instrumental assembly for the ideal key.

2. The method of coupling diatonic harmonicas as claimed in claim 1 further comprises the steps of:
finding a first note and a second note on the chromatic scale,
if the musical key of the initial harmonica is major and the musical key of the subsequent harmonica is major; and
matching the musical key of the subsequent harmonica to the second note.

3. The method of coupling diatonic harmonicas as claimed in claim 2 further comprises the steps of:
finding the first note by incrementally moving one step on the chromatic scale from the musical key of the initial harmonica; and
finding the second note by incrementally moving one step on the chromatic scale from the first note.

4. The method of coupling diatonic harmonicas as claimed in claim 2 further comprises the steps of:
finding the first note by decrementally moving one step on the chromatic scale from the musical key of the initial harmonica; and
finding the second note by decrementally moving one step on the chromatic scale from the first note.

5. The method of coupling diatonic harmonicas as claimed in claim 1 further comprises the steps of:
finding a first note and a second note on the chromatic scale,
if the musical key of the initial harmonica is minor and the musical key of the subsequent harmonica is minor; and
matching the musical key of the subsequent harmonica to the second note.

6. The method of coupling diatonic harmonicas as claimed in claim 5 further comprises the steps of:
finding the first note by incrementally moving one step on the chromatic scale from the musical key of the initial harmonica; and
finding the second note by incrementally moving one step on the chromatic scale from the first note.

7. The method of coupling diatonic harmonicas as claimed in claim 5 further comprises the steps of:
finding the first note by decrementally moving one step on the chromatic scale from the musical key of the initial harmonica; and
finding the second note by decrementally moving one step on the chromatic scale from the first note.

8. The method of coupling diatonic harmonicas as claimed in claim 1 further comprises the steps of:
finding a first note, a second note, and a third note on the chromatic scale,
if the musical key of the initial harmonica is major and the musical key of the subsequent harmonica is minor; and
matching the musical key of the subsequent harmonica to the third note.

9. The method of coupling diatonic harmonicas as claimed in claim 8 further comprises the steps of:
finding the first note by decrementally moving one step on the chromatic scale from the musical key of the initial harmonica;
finding the second note by decrementally moving one step on the chromatic scale from the first note; and
finding the third note by decrementally moving one step on the chromatic scale from the second note.

10. The method of coupling diatonic harmonicas as claimed in claim 1 further comprises the steps of:
finding a first note, a second note, and a third note on the chromatic scale,
if the musical key of the initial harmonica is minor and the musical key of the subsequent harmonica is major; and
matching the musical key of the subsequent harmonica to the third note.

11. The method of coupling diatonic harmonicas as claimed in claim 10 further comprises the steps of:
finding the first note by incrementally moving one step on the chromatic scale from the musical key of the initial harmonica;
finding the second note by incrementally moving one step on the chromatic scale from the first note; and
finding the third note by incrementally moving one step on the chromatic scale from the second note.

12. The method of coupling diatonic harmonicas as claimed in claim 1, wherein the root hole of each of the plurality of harmonicas is the first hole corresponding to the first note of the respective scale of each of the plurality of harmonicas.

13. The method of coupling diatonic harmonicas as claimed in claim 1 further comprises the steps of:
traversing the clamping mechanism through both the initial harmonica and the subsequent harmonica.

14. The method of coupling diatonic harmonicas as claimed in claim 1 further comprises the steps of:
encompassing the clamping mechanism perimetrically about both the initial harmonica and the subsequent harmonica.
